(19) United States
(12) Patent Application Publication
(10) Pub. No.: US 2025/0168514 A1
(43) Pub. Date: May 22, 2025

(54) OBSERVATION DEVICE

(71) Applicant: UAB Yukon Advanced Optics Worldwide, Vilnius (LT)

(72) Inventor: Aliaksandr Alsheuski, Vilnius (LT)

(21) Appl. No.: 18/841,792

(22) PCT Filed: Feb. 28, 2023
(86) PCT No.: PCT/EP2023/054987

§ 371 Date: Aug. 27, 2024

(30) Foreign Application Priority Data
Feb. 28, 2022 (GB) 2202709.8

(51) Int. Cl. H04N 23/72; H04N 23/20; H04N 23/71; H04N 23/73; H04N 23/74; H04N 23/741

(52) U.S. Cl. CPC H04N 23/72; H04N 23/20; H04N 23/71; H04N 23/73; H04N 23/74; H04N 23/741

(57) ABSTRACT

An observation device, such as a night vision device, a range finder, a sighting device, or a scope, with a more useful night vision image during use. One embodiment obtains night-vision images of a scene at different illuminations and merging the night-vision images, resulting in a merged image that exhibits greater dynamic range than any of the individual night-vision images. This may be achieved by selecting regions in each image which contain the greatest image detail and combining the selected regions from each image into a single image which exhibits greater image detail as a result. Illumination may be provided at different illumination levels and/or at different beam angles, and may be provided by the same or by different illuminators. Another embodiment also obtains night-vision images of a scene at different illuminations and determines the level of detail of an object of interest in a first night-vision image at a first illumination so as to determine a second illumination that increases the level of detail in a second night-vision image.

The present invention relates to observation devices such as night vision devices, range finders, sighting devices, scopes, and the like, as used by explorers, hunters, fishermen and nature enthusiasts for various activities. In particular, the present invention relates to various improvements to night vision devices which result in increased functionality and improved utility, by presenting a user with a more useful night vision image during use.

### BACKGROUND TO THE INVENTION

Observation devices such as night vision devices, thermal devices, range finders, sighting devices, scopes, and the like, are used by explorers, hunters, fishermen and nature enthusiasts for various activities.

So-called “active” night vision devices, which include digital and image intensifier night vision devices, rely on infrared illuminators for improved performance over “passive” night vision devices which are inherently range-limited. Infrared illuminators are used to illuminate an area or an object (which may be a target) with light which is invisible to the human eye, and active night vision devices include a sensor such as a CCD or CMOS sensor which is sensitive to the light from the illuminator. This is also in contrast to thermal imaging devices which detect thermal infrared and do not require an illuminator.

The Applicant has identified a significant problem with conventional arrangements in that when imaging objects at distance, other objects which are closer to the night vision devices will inevitably reflect a high proportion of light from the illuminator. Automatic brightness compensation will react to this, reducing the overall brightness of the image, with the unwanted effect that it becomes impossible to see those objects at distance. It is possible to increase the brightness of the image manually but this generally has the effect of bleaching the foreground of the image thus obscuring objects closer to the night vision device.

Another problem that can result from this situation is that it can be difficult to observe objects which are behind a target or object of interest. In the specific example of a rifle scope, it is essential for the operator to know what is behind a target in case of a miss or projectile pass-through. If the target or object of interest is illuminated or at least calibrated for in the image generated by the device, it is highly likely that such ancillary features are rendered invisible. It is therefore difficult for the operator to make judgements or take actions without significant risk of collateral or unintended damage or loss.

It is known to apply image enhancing techniques in order to sharpen images and increase detail, but such approaches may introduce artefacts and in any case rely on having sufficient image data for such enhancement techniques to bring out the desired detail.

It is also known to enhance images obtained with observation devices by combining image data from multiple sources. For example, the concept of “Fusion” as it relates to such devices describes a type of product which augments or combines (“fuses”) images from two different image sources. However the resulting image tends to be of poor quality and while infrared data might augment and/or enhance a night-vision image in some ways it has a tendency to obscure detail that would otherwise be helpful. It is also challenging to compensate for image displacement, magnification differences, viewing angles, and differences in image quality and levels, it increases cost and complexity, and in any case does not address the brightness problem.

It is an object of at least one aspect of the present invention to provide an observation device which addresses the issues above and/or provides increased functionality and improved utility over conventional observation devices.

Further aims and objects of the invention will become apparent from reading the following description.

### SUMMARY OF THE INVENTION

According to a first aspect of the invention there is provided an observation device, the observation device comprising:
a night vision imaging module; and
image processing means;
wherein the night vision imaging module is configured to capture a first night vision image of a scene and a second night vision image of substantially the same scene; and
wherein the image processing means is configured to generate a merged night-vision image from the first image and the second image that exhibits a greater dynamic range than the first image or the second image alone.

Preferably, the first night-vision image is captured at a first illumination and the second night-vision image is captured at a second illumination.

Preferably, the observation device comprises an illuminator which is controlled to provide illumination at first and second illumination levels. Alternatively, the observation device comprises a first illuminator which provides illumination at a first illumination level and a second illuminator which provides illumination at a second illumination level.

In a simple implementation, the first night-vision image is captured at a low level of illumination, and the second night-vision image is captured at a high level of illumination. This can be achieved by controlling a single illuminator or switching between two different illuminators.

Alternatively, or additionally, the observation device comprises an illuminator which is controlled to provide illumination over first and second beam angles. Alternatively, the observation device comprises a first illuminator which provides illumination at a first beam angle and a second illuminator which provides illumination at a second beam angle.

In a simple implementation, the first night vision image is captured with illumination at a narrow beam angle and the second night vision image is captured with illumination at a wide beam angle. This can be achieved by controlling a single illuminator or switching between two different illuminators.

A narrow beam angle provides concentrated lighting and may be used to illuminate a target or object of interest, whereas a wide beam angle provides more diffuse or spread-out lighting and may be used to illuminate the background, foreground and/or areas surrounding the target of object of interest simultaneously.

In more complex implementations, the first night vision image is captured with illumination of a first level over a first beam angle, and the second night vision image is captured with illumination of a second level over a second beam angle. For example, the first night vision image may be captured with low power illumination over a wide beam angle, and the second night vision image may be captured with high power over a narrow beam angle. Any combination is possible and selection depends on the environment and composition of the scene. For example, a more balanced image may be achieved by using low power illumination with a narrow focus to obtain a night vision image of a target or object and by using a broadly diffuse but high power illumination to obtain a night vision image of the surroundings of similar brightness.

Optionally, the image processing means is configured to generate the merged night vision image from the first image, the second image, and any additional images, using tone mapping. Alternatively, or additionally, the image processing means is configured to generate the merged night vision image from the first image, the second image and any additional images, using exposure fusion.

Optionally, the first night-vision image of the scene is captured at a first exposure and the second night-vision image is captured at a second exposure.

In a simple implementation, the first image of the scene is captured at a (relatively) long shutter time and the second image of substantially the same scene (ideally the same scene but some movement between image captures is to be expected) is captured at a (relatively) short shutter time, or vice versa. Put another way, the first and second images may be captured at different shutter times (or speeds).

In another simple implementation, the first image of the scene is captured at a (relatively) small aperture size and the second image of substantially the same scene (ideally the same scene but some movement between image captures is to be expected) is captured at a (relatively) large aperture size, or vice versa. Put another way, the first and second images may be captured at different aperture sizes.

In more complex implementations, the first and second (and any further) exposures comprise different combinations of shutter times (or speeds) and different aperture sizes.

Preferably, the first exposure (for the first night vision image) is selected to emphasise detail in a first region of the scene (for example in combination with a first illumination), and the second exposure (for the second night vision image) is selected to emphasis detail in a second region of the scene (for example in combination with a second illumination). Exposures for additional night vision images may be selected to emphasise respective additional regions of the scene.

The first region of the scene might be the foreground and/or contain an object of interest and the second region of the scene might be the background or the area surrounding the object of interest, or vice versa. Alternatively, or additionally, the first region of the scene may be an area of relatively high brightness and the second region of the scene may be an area of relatively low brightness. Additional regions of the scene in additional night vision images may be regions of intermediate brightness.

Optionally, the night vision imaging module is configured to capture a plurality of night vision images (including the first and second images and one or more additional images) of substantially the same scene (ideally the same scene but some movement between image captures is to be expected), at a plurality of different illuminations, and optionally exposures. The image processing means may be configured to generate a merged image from the plurality of images which exhibits a greater dynamic range than any of the plurality of night-vision images alone.

Merging the first image, the second image, and any additional images, may include identifying preferred or desired parameters or quantities of each image, generating a corresponding weight map for each image, and combining the first image, the second image, and any additional images using weighted blending based on the weight maps. Preferably, regions of low detail and/or low contrast are allocated a low weight in the respective weight map. Alternatively, or additionally, regions of zero or near-zero brightness and regions of maximum or near-maximum brightness are allocated a low weight in the respective weight map.

Put another way, the image processing means may be configured to generate the merged night vision image by selecting regions from the first image, the second image, and any additional images which contain greatest image detail, and combining the selected regions from the first image, the second image, and any additional images into a single image. The regions in the images may overlap.

Optionally, the illumination, and optionally the exposure, is controlled responsive to a brightness of the merged night vision image. The illumination, and optionally the exposure may be reduced (or increased) if the image brightness exceeds (or falls below) a threshold. As noted below, in another aspect of the invention controlling the illumination can provide a standalone method of achieving improved night vision without the need to generate merged night vision images.

Optionally, the observation device is configured to determine the distance to a target or object of interest. The distance may be determined based on the focussing distance of the night vision imaging module, which may be set manually or automatically (for example by an auto-focussing system). Or, the distance may be determined using a rangefinder. Alternatively, the distance may be set manually. The observation device may be configured to control the illumination and optionally the exposure responsive to the distance.

Optionally, the observation device comprises one or more additional imaging modules. The one or more additional imaging modules may be selected from the group comprising a thermal camera or thermal scope, an infrared camera or infrared scope, and a visible camera or visible scope. The one or more additional imaging modules may comprise a CMOS sensor, CCD camera, thermographic camera, or the like.

The image processing means may be configured to generate a composite image in which a portion of an image obtained by the additional imaging module (or one of the additional imaging modules) is superimposed on the merged night vision image generated by the image processing means, or vice versa.

Optionally, the image processing means may be configured to generate the merged night vision image from the first and second night vision images, any additional night vision images, and one or more images obtained by the additional imaging module (or one of the additional imaging modules).

Most preferably, the merged image is updated in real time. That is, the night vision imaging module captures first and second (and any additional) images continuously and the merged image is generated continuously. Put another way, the merged image generated by the processing means is live.

Preferably, the observation device further comprises a display module configured to display the merged image. The display module may be removably attached to the observation device. Alternatively, the display module may be integrated with the night vision imaging module (and any additional modules) within a single housing.

The display module may be monocular or binocular.

Alternatively, or additionally, the observation device is configured to generate a video feed of the merged image, the first and second (and any additional) images captured by the night vision imaging module, and/or (where appropriate) images captured by additional imaging modules. The source of the video feed may be selected by a user.

Preferably, the observation device is configured to overlay a reticle on the merged night vision image. The reticle may take any suitable or desirable form but preferably comprises cross hairs.

According to a second aspect of the invention, there is provided a method of generating a night vision image of a scene, the method comprising:
capturing a first night vision image of the scene;
capturing a second night vision image of substantially the same scene; and
generating a merged night vision image from the first image and the second image that exhibits a greater dynamic range than the first image or the second image alone.

Preferably, the first night vision image is captured at a first illumination level and the second night vision image is captured at a second illumination level. Preferably, the method comprises controlling one or more illuminators to provide different levels of illumination and/or different illumination beam angles.

Optionally, the first night vision image is captured at a first exposure and the second night vision image is captured at a second exposure. The first and second exposures might comprise different shutter times (or speeds) and/or different aperture sizes.

Alternatively, or additionally, the method comprises controlling the illumination and optionally the exposure responsive to a brightness of the merged night vision image. Preferably, the method comprises reducing the illumination and/or exposure if the brightness exceeds a threshold, and increasing the illumination and/or exposure if the brightness falls below a threshold.

Optionally, the method comprises controlling the illumination and optionally the exposure responsive to the distance to a target or object of interest. The method may comprise determining the distance.

Embodiments of the second aspect of the invention may comprise features corresponding to the preferred or optional features of any other aspects of the invention or vice versa.

According to a third aspect of the invention there is provided an observation device, the observation device comprising:
a night vision imaging module; and
image processing means;
wherein the night vision imaging module is configured to capture a first night vision image of a scene at a first illumination and a second night vision image of substantially the same scene at a second illumination; and
wherein the image processing means is configured to determine the level of detail of an object of interest in the first night vision image and determine the second illumination to increase the level of detail of the object of interest in the second night vision image.

Preferably, the second illumination is different from the first illumination.

Preferably, the observation device comprises an illuminator which is controlled to provide illumination at the first and second illuminations. Alternatively, the observation device comprises a first illuminator which provides illumination at a first illumination and a second illuminator which provides illumination at a second illumination.

Alternatively, or additionally, the observation device comprises an illuminator which is controlled to provide illumination over first and second beam angles. Alternatively, the observation device comprises a first illuminator which provides illumination at a first beam angle and a second illuminator which provides illumination at a second beam angle.

In a simple implementation, the first night vision image is captured with illumination at a narrow beam angle and the second night vision image is captured with illumination at a wide beam angle. This can be achieved by controlling a single illuminator or switching between two different illuminators.

Optionally, the night vision imaging module is configured to capture a plurality of night vision images (including the first and second images and one or more additional images) of substantially the same scene (ideally the same scene but some movement between image captures is to be expected), at a plurality of different illuminations. The image processing means may be configured to change the illumination iteratively until a desired level of detail is achieved. Alternatively the illumination may be changed discontinuously. Preferably, this is done in real time.

Optionally, the image processing means is configured to determine the level of detail of the object of interest based on the degree of contrast in the first image. Alternatively or additionally, the image processing means is configured to determine the level of detail of the object of interest based on a comparison between the mean and the median brightness of pixels in the first image. Alternatively, or additionally, the image processing means is configured to analyse a histogram and determine an illumination to increase or maximise the number of intensity values within the histogram.

Optionally, the observation device is configured to determine the distance to the object of interest. The distance may be determined based on the focussing distance of the night vision imaging module, which may be set manually or automatically (for example by an auto-focussing system). Or, the distance may be determined using a rangefinder. Alternatively, the distance may be set manually. The observation device may be configured to control the illumination responsive to the distance.

Optionally, the observation device comprises one or more additional imaging modules. The one or more additional imaging modules may be selected from the group comprising a thermal camera or thermal scope, an infrared camera or infrared scope, and a visible camera or visible scope. The one or more additional imaging modules may comprise a CMOS sensor, CCD camera, thermographic camera, or the like.

Preferably, the observation device further comprises a display module. The display module may be removably attached to the observation device. Alternatively, the display module may be integrated with the night vision imaging module (and any additional modules) within a single housing.

The display module may be monocular or binocular.

Alternatively, or additionally, the observation device is configured to generate a video feed. The source of the video feed may be selected by a user.

According to a fourth aspect of the invention, there is provided a method of generating a night vision image of a scene, the method comprising:
capturing a first night vision image of the scene at a first illumination;
analysing the first night vision image of the scene; and
capturing a second night vision image of substantially the same scene at a second illumination;
wherein analysing the first night vision image of the scene includes determining the level of detail of an object of interest in the first night vision image and determining the second illumination to increase the level of detail of the object of interest in the second night vision image.

Preferably, the second illumination is different from the first illumination. Preferably, the method comprises controlling one or more illuminators to provide different levels of illumination and/or different illumination beam angles.

Optionally, the method comprises controlling the illumination responsive to a brightness and/or contrast of the object of interest in the night vision image. Preferably, the method comprises reducing the illumination if the brightness exceeds a threshold and/or if the contrast is below a threshold, and increasing the illumination if the brightness falls below a threshold and/or if the contrast exceeds a threshold.

Optionally, the method comprises controlling the illumination responsive to the distance to the object of interest. The method may comprise determining the distance.

Embodiments of the fourth aspect of the invention may comprise features corresponding to the preferred or optional features of any other aspects of the invention or vice versa.

According to a fifth aspect of the present invention, there is provided a scope or sighting device comprising an observation device according to the first or the third aspect.

The observation device may be comprised in the scope or sighting device. Alternatively, the observation device may be removeably attached to the scope or sighting device. The observation device may be configured as a rifle scope front attachment.

The scope may comprise a display module of the observation device. The night vision imaging module may be removably attached to the scope, or from the rifle scope front attachment. Optionally, the night vision imaging module may be replaced or supplemented with a like or alternative imaging module.

Embodiments of the fifth aspect of the invention may comprise features corresponding to the preferred or optional features of the first or third aspects or to implement the preferred or optional features of the second or fourth aspects of the invention or vice versa.

### BRIEF DESCRIPTION OF DRAWINGS

There will now be described, by way of example only, various embodiments of the invention with reference to the drawings (like reference numerals being used to denote like features, whether expressly mentioned in the detailed description below or not), of which:

FIG. 1 is a schematic view of an observation device according to an aspect of the present invention;

FIG. 2 illustrates the process by which a merged night vision image is produced from two separate night vision images;

FIG. 3 illustrates the process by which a merged night vision image is produced from a sequence of separate night vision images;

FIG. 4 is a schematic view of a rifle scope incorporating an observation device according to the present invention;

FIG. 5 is a schematic view of a rifle scope with a front attachment comprising an observation device according to the present invention;

FIG. 6 is a process diagram summarising the process by which a merged night vision image is generated and displayed to a user;

FIG. 7 is a process diagram summarising the process shown in FIG. 6 in the case where the merged night vision image is generated based on night vision images having different illumination settings; and

FIG. 8 is a schematic view of an observation device according to another aspect of the present invention; and

FIG. 9 is a process diagram summarising the process by which the level of detail of an object of interest is increased by changing illumination settings.

Unless stated otherwise, features in the drawings are not to scale. Scales are exaggerated in order to better illustrate the features of the invention and the problems which the invention are intended to address.

### DETAILED DESCRIPTION OF THE PREFERRED EMBODIMENTS

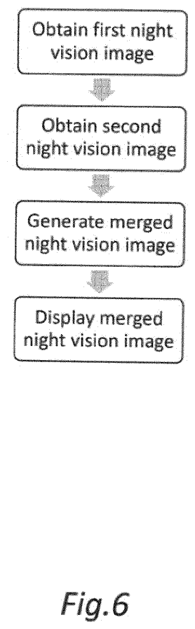

The present invention may be realised in a variety of different embodiments but in the description which follows each described embodiment will primarily focus on one particular approach to generating a night-vision image of greater dynamic range or showing more detail of a scene or an object of interest within the scene than can be achieved with conventional night-vision imaging devices. Exemplary but non-limiting processes are summarised in the process diagrams of FIGS. 6, 7 and 9.

In a first embodiment a merged night-vision image is produced by combining two or more night-vision images obtained with different illumination profiles. In this context, obtaining night-vision images with different illumination profiles include that the two or more night-vision images are obtained while the scene (or parts of the scene) are being illuminated at different brightnesses, or with different beam angles, or a combination of different brightnesses and beam angles. Optionally, the different night vision images can be obtained at different exposures.

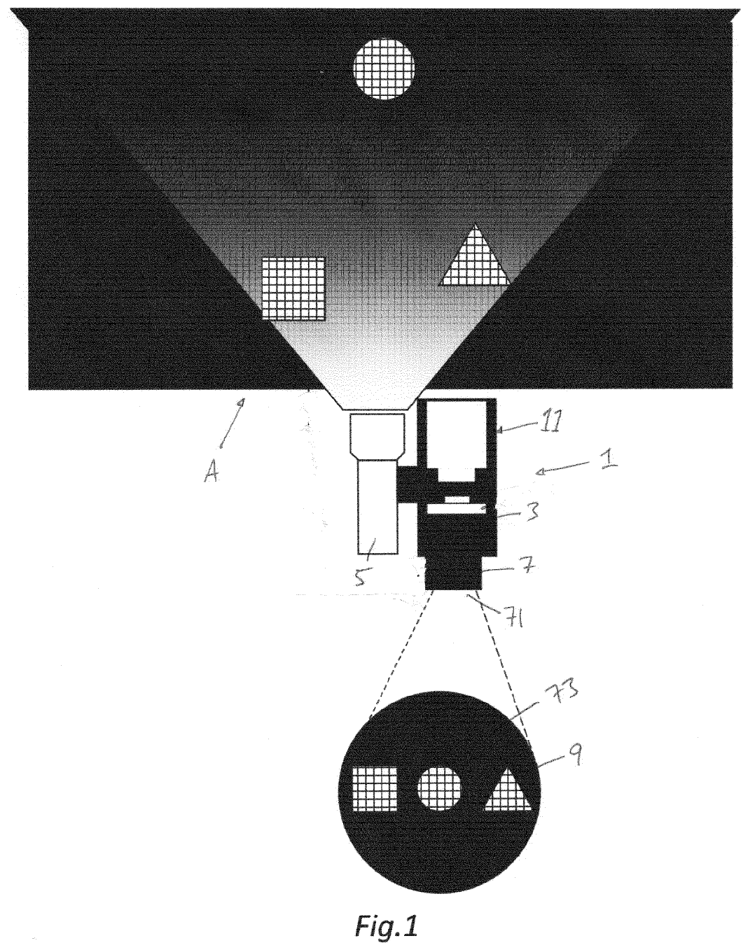

FIG. 1 is a schematic view of an observation device 1 which can be seen to comprise a night-vision imaging module 3, an illuminator 5, and a display module 7. The observation device also comprises a housing 11, which integrates or houses the night-vision imaging module 3, illuminator 5, and display module 7 in a single, self-contained or standalone device. Note that in some embodiments the illuminator may be removable from the observation device, and in some cases can be omitted.

An area of interest A is shown schematically, within which are located three objects, two in the foreground (represented by a square and a triangle) and one in the distance (represented by a circle). For the purposes of the examples which follow, the circle represents the object of interest. Overlaid on the area of interest is a schematic representation of the field of illumination of the illuminator, using a gradient to represent the reduction in intensity as a function of distance (in accordance with Beer-Lambert).

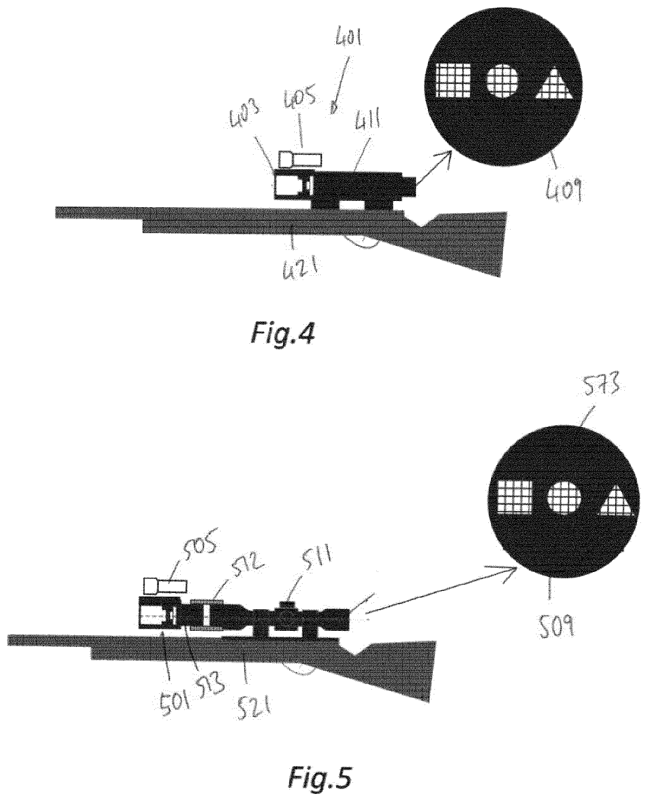

Shown in the inset is an image 9 of the area of interest as viewed through an eyepiece or viewing aperture 71 of an electronic view finder (EVF) 73 within the display module 7. The image 9 may be that observed by a user in the event the observation device is a standalone device, or that which is subsequently imaged by or viewed through a scope (e.g. see discussion of FIGS. 4 and 5 below) when the observation device is an attachment or “bolt-on” to a separate device.

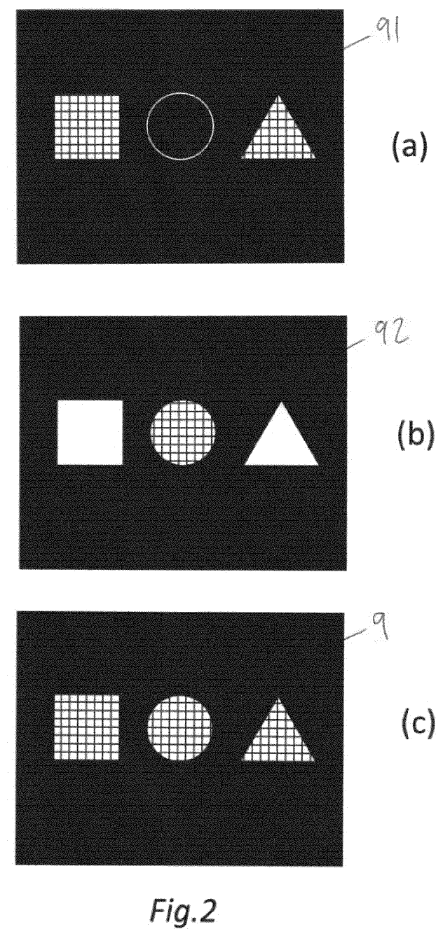

The image 9, which may be termed a merged image, is formed from at least two separate night-vision images (see for example FIG. 2) captured by the night-vision imaging module 3. In the merged image, and in the separate images and/or sub-images discussed below, objects shown in desired or at least sufficient detail are represented by a grid in-fill, whereas objects which are overexposed (and potentially bleached) are represented by a solid white in-fill, and objects which are underexposed (and potentially invisible) are represented by a solid black in-fill. In FIG. 1, each of the three objects in the merged image (represented by a square, a circle, and a triangle) are shown in desired or at least sufficient detail, and as such each is represented by a grid-infill.

Processes by which said merged image may be generated will now be described with reference to various drawings.

As described above, the Applicant has recognised that active night vision devices are deficient when imaging objects at distance in several regards, and these deficiencies are solved in various ways by this and other embodiments of the invention. For example, when imaging a target or object of interest, other objects which are closer to a night vision device (or which have a relatively high reflectivity or optical brightness) will inevitably reflect a high proportion of light from an illuminator.

While automatic brightness compensation (which can be included in embodiments of the invention) would react to this and reduce the overall brightness of the image, it may then become impossible to see the target or object of interest. Even when the target or object of interest is clearly imaged it can be difficult to observe objects which are behind a target or object of interest.

FIG. 2(a) shows a first night vision image 91 obtained by the night vision imaging module 3 in which the two foreground objects (represented by a square and a circle) are clearly visible against a dark background. This first night vision image 91 is obtained at a first, relatively low power illumination which captures the foreground objects in detail (represented by a square and a triangle with a grid in-fill). However, the object of interest (represented by a circle) is not visible or is only partly visible. FIG. 2(b) shows a second night vision image 92 obtained by the night vision imaging module at a second, relatively high power illumination at which the object of interest is made visible. In relation to the first image 91, the two foreground objects in the second image 92 might be considered over-exposed, resulting in image bleaching and an undesirable loss of detail in the image of these objects (represented by the solid colour in-fill). However, while in the first image 91 the foreground objects are well-captured, the object of interest is not visible because insufficient light has reached the sensor during the exposure time. The second image 92, by virtue of the higher power illumination, has captured sufficient light from the object of interest within the same exposure time.

Note that while it is preferred that the night vision imaging module exposure settings remain constant with only the level of illumination changing between successive images, it is foreseen that the exposure can also be adjusted in combination with the level of illumination to fine-tune the resulting merged image.

A merged night-vision image 9 is generated by merging the first 91 and second 92 images. Merging can be achieved in various ways, some of which will be familiar to the skilled person, such as tone mapping or exposure fusion. In most cases however the merging of the images has the effect of selecting or identifying regions in each image which contain the most or greatest image detail, and prioritising those regions when the images are merged. Compared with the “raw” first 91 and second 92 images, the foreground objects and the object of interest are rendered clearly in the merged night vision image 9 shown in FIG. 2(c).

One way of achieving this outcome is to analyse and generate a corresponding weight map for each of the first and second night vision images. The weight map allocates a weighting to each region (or indeed each pixel) of the image according to predetermined criteria. For example, areas of very high brightness and of very low brightness (which might indicate a lack of detail) can be given a low weighting, thus prioritising image data in the mid-ranges which are likely to contain more detail. This, for example, would place a low priority on “bleached” areas of an image and likewise very dark areas of an image, with the expectation that greater detail in the respective areas will be obtained from other images with different levels of illumination. In another example, areas containing or bounded by high contrast (which might indicate the presence of detail or of object boundaries) might be given a high weighting, whereas areas of low contrast (which might also identify over-exposed and/or underexposed areas of an image) might be given a low weighting. When the respective night vision images are then merged, for example using weighted blending, the weight maps determine the extent to which each region (or indeed each pixel) contributes to the merged image.

This example is of course simplified for the purposes of explaining the invention clearly, and same or similar night vision images and merged night vision images can be obtained in a number of analogous ways (as will be described below). It will also be understood that once generated, the merged image can be adjusted automatically for display in conventional ways; for example overall brightness and contrast etc. adjusted to produce a good quality image on the display module 7. It should also be understood that while the example describes two night vision images being merged, any number of night vision images may be merged in order to generate the merged night vision image. That night vision images are generally monochrome (grayscale) makes the image processing and merging much easier but the same approaches can be used with colour images.

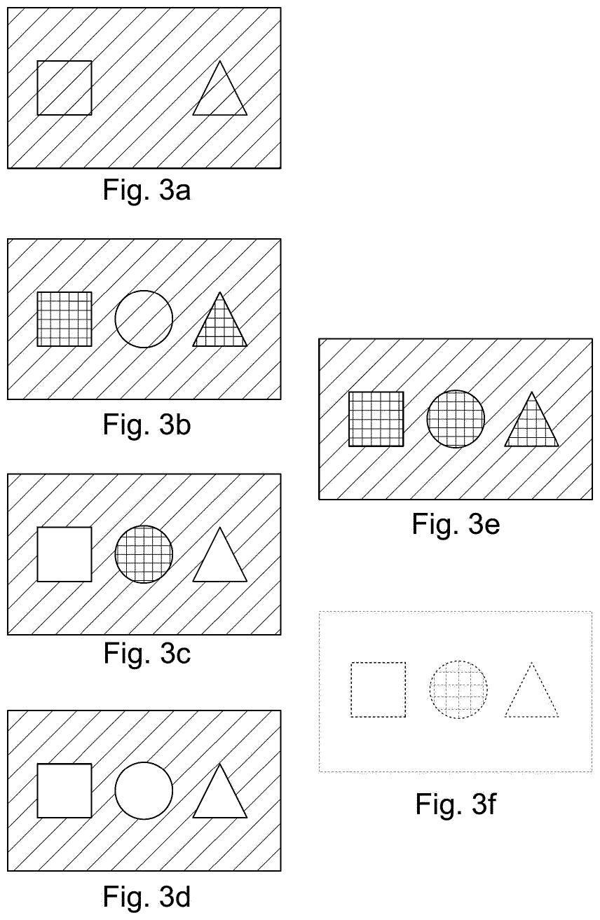

FIG. 3 illustrates how a merged night vision image can be generated from a larger number of night vision images obtained by the night vision imaging module 3. In this example, which as intimated above is an extension of the previous embodiment but employing several night vision images, it is envisaged that greater levels of detail within the merged night vision image can be achieved. The four separate night vision images (a)-(d) shown on the left are taken at different levels of illumination (i.e. different brightnesses). In comparison with in the previously described example, the first image, at the lowest level of illumination, produces an image in which the object of interest is not visible and the foreground objects are barely visible, and the following three images are taken at increasing levels of illumination (i.e. increasing illuminator brightness). In the first image (a) for example, the entire image would be given a low weighting, in the second image (b) the regions of the two foreground objects would be given a high weighting due to the presence of detail, in the third image (c) the region of the object of interest would be given a high weighting and the regions of the two foreground objects would be given a lower weighting due to the lack of detail but not as low as in image (a) because of the contrast with the background, and in the fourth image (d) the region of the object of interest would be given a lower weighting, reflecting the lack of detail in the over-exposed image but the presence of contrast with the surroundings.

The resulting merged image (e) is shown on the upper right, in which the second object is visible with good contrast to the background. This outcome is far preferable to and renders a far more useful night vision image than the conventional approach of simply increasing the exposure (i.e. reducing shutter speed) until an object of interest can be viewed in sufficient/desired detail. Image (f) is representative of a night vision image where exposure has simply been increased (i.e. shutter speed reduced) with the result that while the object of interest is made visible the contrast between the object of interest and the foreground objects, and even the contrast with the background, is significantly reduced (which might affect, amongst other things, depth perception).

As described above, in the specific example of a rifle scope, it is essential for the operator to know what is behind a target in case of a miss or projectile pass-through, and the present invention clearly enables this to be achieved by generating a merged image from one or more images which contain detail of the target as well as one or more images which contain detail of the surroundings. If the target or object of interest is illuminated or at least calibrated for in the image generated by a conventional device, such ancillary features may be invisible, see FIG. 2(b) and FIG. 3(c) for example. The present invention therefore allows an operator to make judgements or take actions without significant risk of collateral or unintended damage or loss, because the surroundings, foreground and/or background of the target or object of interest are also captured in the merged night vision image.

By way of example, in the example illustrated in FIG. 3, the object of interest was represented by the circle. Consider now that the object of interest is actually represented by the square. In FIG. 3(b) the square is visible in sufficient detail as is the triangle, so as to be a useful image of the object represented by the square with similar visibility of a neighbouring object. Decisions and actions can be taken in relation to the object represented by the square in the knowledge or in such a way that the object represented by the triangle is unaffected. However, this might result in damage or other negative effect to the object represented by the circle which is barely visible. Only when presented with the merged image shown in FIG. 3(e) can all relevant factors be taken into account. In a dramatic example, a hunter wishing to fire upon a game animal and having trained his sights on the animal and configured his night vision apparatus accordingly may not be able to see a person (e.g. a fellow hunter) lurking behind the game animal without the enhanced imagery which the present invention enables. Thus the present invention vastly reduces the risk that the other person is accidentally shot or otherwise injured.

Although the observation device 1 is described above as being a single, standalone device, in an alternative embodiment (not shown) a night vision imaging module, an illuminator, and a display module may be separate, modular components that are attached in use but can be disassembled and reattached in a different configuration depending on the particular use case or application. Furthermore, this would allow the night vision imaging module and/or the illuminator to be replaced with alternative imaging modules and/or illuminators, and the display module likewise. This might be for repair purposes, to allow a user to upgrade their device, to provide a larger display, or to accommodate integration in other systems.

Note that the display module may be monocular or binocular. If the display module is monocular it is foreseen that it could be made binocular by adding another like display module.

The observation device 1 is also described as being standalone in the context of being a device which a user can use independent of any other equipment to observe a scene and generate a corresponding merged night vision image, but as intimated above the observation device 1 may be fitted to or integrated with a rifle or other type of scope, or alternatively configured as a rifle or other type of scope, such as illustrated in FIG. 4 and FIG. 5.

For example, in a modular embodiment the display module might be removed to attach the observation device to a scope, for example a digital scope, which takes the place (or serves the purpose) of the display module. In another example, the observation device may not be provided with a display module at all, and configured for the express purpose of attaching to a scope, for example a digital scope. It is also possible that the image provided by a display module might be viewed through a scope.

In FIG. 4 a rifle sight 411 incorporates night vision imaging module 403 and illuminator 405 in a unitary body, or put another way the observation device 401 is itself configured as a rifle scope whereas in FIG. 5, an observation device 501 is in the form of a so-called “front attachment” and is shown attached to a rifle sight 511. In the embodiment shown in FIG. 4 the display module might include the scope objective 413 or the scope objective 413 might effectively be the display module, whereas in the embodiment shown in FIG. 5 the observation device 501 is configured to enable a user to view the display module through the scope objective 513. It is foreseen, for example, that an observation device might output a video feed comprising the merged image. This video feed may be input into any suitable display and/or recording device or system or transmitted, for example, to a smartphone app or the like. For the purposes of the present description, and by way of example only, the video feed may be input to a digital rifle scope.

When embodied in a rifle scope the scope 411 is preferably configured for attachment to a rifle 421 using standard means such as retaining rings or scope rings. The manner of attachment is unimportant and to a large degree irrelevant; what is important is the technical features which may be common to all embodiments regardless of application. Primarily, this is the ability of a user to view a merged night vision image containing more detail than a conventional night vision image as discussed above, but there may also be secondary, advantageous but non-essential features of preferred embodiments which are now described in the rifle scope context but which apply to other embodiments such as spotting scopes, rangefinders, and the like.

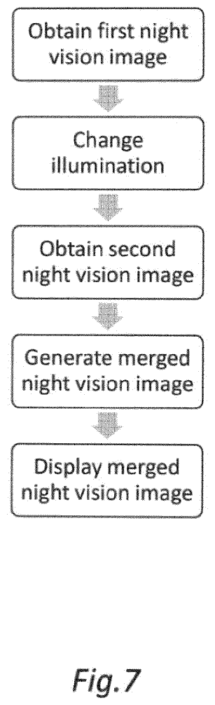

Shown in the inset of FIG. 4 is an image 409 as viewed through scope objective 413. As described above, the image 409 is generated by obtaining two or more night vision images and merging the two or more night vision images to generate a merged night vision image 409 (see also the process summarised in FIG. 6). In the embodiment described above, the different night vision images are obtained at different illuminations (see also the process summarised in FIG. 7) and specifically at different illuminator brightnesses. It is also envisaged that instead of using different brightnesses, the different night vision images can be obtained with different focusses or fields of illumination; the different focusses or fields of illumination also being able to determine how much light is incident on a particular scene or object of interest.

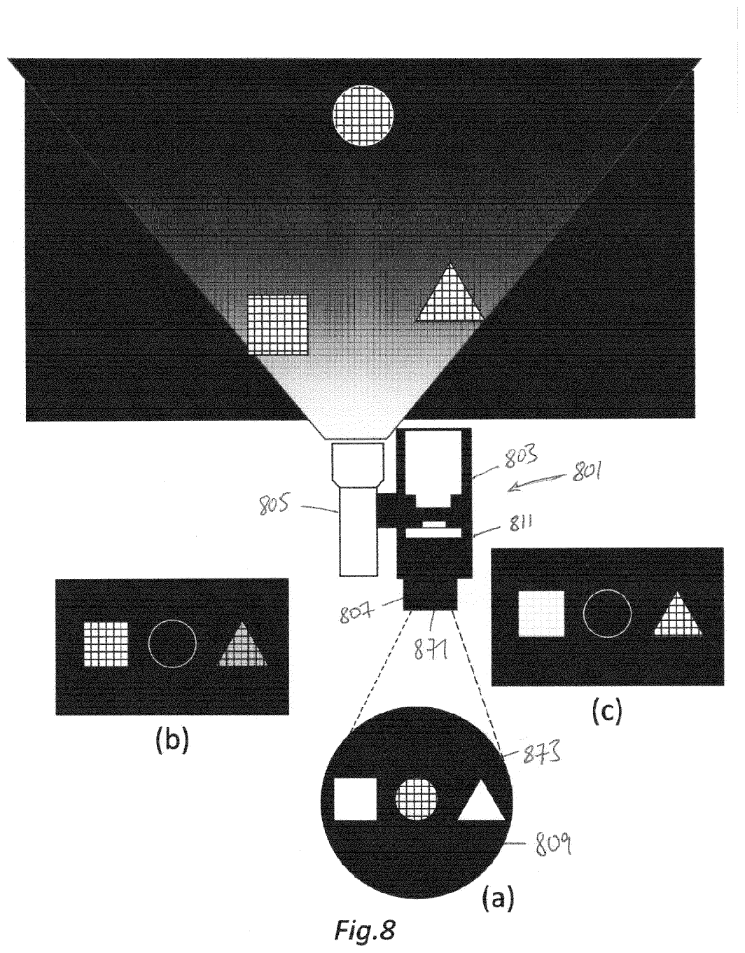

As shown in FIGS. 1, 4 and 5, the observation device is provided with an illuminator 5, 405, 505. The illuminator 5, 405, 505 might be as simple a device as an infrared torch, but it might also incorporate an infrared laser for more collimated and directed illumination. In another embodiment the observation device might be provided with one or more additional illuminators; for example a first illuminator might provide narrow focussed light (to illuminate a target or object of interest) and a second illuminator might provide a broader beam angle (to illuminate the foreground or a scene in general). The illuminator might also be controlled, for example by illuminating different sets of LEDs or controlling their brightness, or controlling focus, to provide different amounts, beam angles and/or directions of illumination. As such, different night-vision images can be obtained using a variety of different illumination parameters (see also the process summarised in FIG. 8).

Once a desired number of night vision images have been captured, at different illumination levels and/or beam angles, a merged night vision image can be generated using the principles as described above. In other embodiments, it is envisaged that different images may be captured at different illumination levels and/or beam angles as well as different exposures. This may be the case, for example, where the illuminators are of a fixed brightness and/or beam angle, and the distance to a target or object of interest varies; it may be necessary to increase exposures to compensate for a reduction in reflected light. Or vice versa, it might be necessary to increase illumination brightness to compensate for limitations due to aperture size or to enable sufficiently fast shutter speeds to avoid motion blurring.

The observation devices herein described or in any alternative embodiment or variant envisaged may be provided with one or more additional imaging modules which are selected to obtain images in a different region of the electromagnetic spectrum. For example, an additional imaging module may capture an image within the visible region of the electromagnetic spectrum or the ultraviolet region of the electromagnetic spectrum. Such additional images can also form part of the merged night vision image, for example to provide additional detail that might not be visible from purely night-vision image data.

Alternatively, the observation device can be operated to switch between displaying the merged night vision image, one or more images from one or more additional imaging modules, or indeed may display the first, second or any additional night vision images from which the merged night vision image is derived. In another embodiment, instead of switching between different image sources, a composite image can be displayed in which the image from the one or more additional imaging modules forms an auxiliary image. The auxiliary image might occupy a region of the composite image which is, say, roughly 20% of area of the merged night vision image on which it is (effectively) superimposed. In use, a user may toggle the image source for the display module such that (again, for example), the sources of the main and auxiliary images change; between a notional default arrangement in which the main image is the merged night vision image and the auxiliary image is a thermal, visible, ultraviolet or other image captured from an additional imaging module, an alternate arrangement in which the main image is obtained from the additional imaging module and the auxiliary image is the merged night vision image, and to view the merged night vision image or the image captured from the additional imaging module alone.

As discussed briefly above, FIG. 5 shows an embodiment of an observation device 501 in the form of a so-called “front attachment” which is attached to a rifle scope 511. A conventional rifle scope front attachment allows an optical rifle scope to be converted into a night vision or thermal rifle scope; in this embodiment the front attachment observation device 501 converts a conventional optical rifle scope into a rifle scope which may then provide one or more of the various advantages of the rifle scope device 401 described above. In the embodiment shown in FIG. 5, the front attachment observation device 501 is attached to the objective part of the rifle scope 511, but it might alternatively be mounted on the rifle in front of the scope 511. A ring adapter 512 (optional) may be used to control the spacing between the objective part of the rifle scope 511 and the display module 513. The display module 513 can be provided with an optical arrangement by which the rifle scope 511 is able to focus on the display 573 such that a user can view the composite image 509 through the rifle scope 511.

In an alternative embodiment or aspect of the invention, a different approach to controlling illumination to obtain improved night vision images is provided. Note that this approach may be effected using same or similar apparatus (i.e. observation devices) as described above. Accordingly, the following description of an observation device and associated methods may also be combined with the foregoing to achieve further utility and function. For example, the observation device described above in different embodiments and implementations (including as a standalone device, a rifle scope or a rifle scope attachment) and associated methods may be interchanged with the observation device and associated methods described below (and vice versa).

FIG. 8 is a schematic view of an alternative observation device 801 which, similar to the observation device shown in FIG. 1, can be seen to comprise a night-vision imaging module 803, an illuminator 805, and a display module 807. The observation device also comprises a housing 811, which integrates or houses the night-vision imaging module 803, illuminator 805, and display module 807 in a single, self-contained or standalone device. Likewise, in some embodiments the illuminator may be removable from the observation device, and in some cases can be omitted.

An area of interest is shown schematically, within which are located three objects, two in the foreground (represented by a square and a triangle) and one in the distance (represented by a circle). In a first example, indicated by inset (a), the circle represents the object of interest. Overlaid on the area of interest is a schematic representation of the field of illumination of the illuminator, using a gradient to represent the reduction in intensity as a function of distance (in accordance with Beer-Lambert's law).

Shown in the inset is an image 809 of the area of interest as viewed through an eyepiece or viewing aperture 871 of an electronic view finder (EVF) 873 within the display module 807. The image 809 may be that observed by a user in the event the observation device is a standalone device, or that which is subsequently imaged by or viewed through a scope (e.g. see discussion of FIGS. 4 and 5 above) when the observation device is an attachment or “bolt-on” to a separate device.

As above, in the image 809, and in the separate images and/or sub-images discussed below, objects shown in desired or at least sufficient detail are represented by a grid in-fill, whereas objects which are overexposed (and potentially bleached) are represented by a solid white in-fill, and objects which are underexposed (and potentially invisible) are represented by a solid black in-fill. In FIG. 8, inset (a) the circle is captured in sufficient detail and is therefore represented by a grid-infill, whereas the square and the triangle are overexposed and therefore shown in solid white in-fill. In this case the circle is the object of interest.

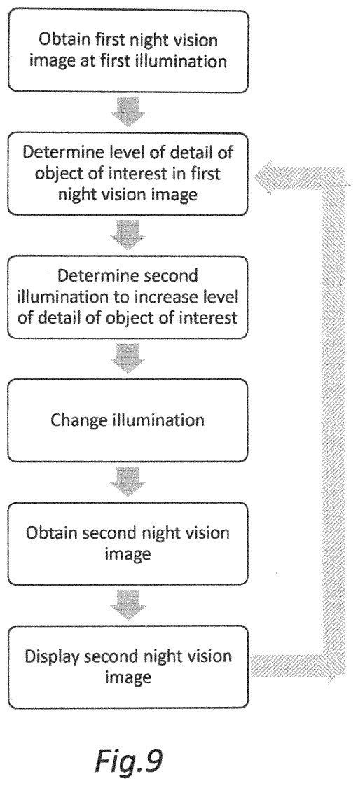

Processes by which a desired night vision image of the other objects may be obtained will now be described with reference to FIG. 8 and FIG. 9. In FIG. 8, inset (a), the circle (which is the object of interest) is shown in sufficient detail but the square and triangle are overexposed as discussed above. If, however, the object of interest is (or becomes) the square for example, it can be determined that the square is overexposed and as such that the level of illumination should be reduced. This determination might be an absolute determination, in that a particular value of illumination is determined and the level switched accordingly, or it may be performed iteratively by reducing the illumination in a continuous or linear manner, or incrementally, until the desired level of detail is achieved. See inset (b) and also dashed arrow in FIG. 9 indicating this optional iterative process of refining the level of illumination, wherein upon each iteration the previous second night vision image becomes the current first night vision image. This may be preferred as a user will observe a gradual adjustment rather than a discontinuous change in the displayed image. A determination of sufficient detail, or some measure of detail, might be based on the degree of contrast within the region of interest; in the description above it is explained how contrast can be a basis for weighting in a merged image; in this case contrast can be a measure of detail.

Other ways of determining the level of detail in a region of the image might be employed, alone or in any possible combination, without limiting the invention. For example, within a specified region of the image, which might be predefined or user-selectable, there may be a comparison between the mean and the median brightness of pixels within the region and the level of illumination selected or adjusted to minimise the difference. Alternatively, there may be an analysis of a histogram of the region and the level of illumination selected or adjusted to increase or maximise the number of intensity values within the histogram.

Of course the reverse applies, if the observation device for example initially images the square in sufficient detail as per inset (b) and it is desirable to then image the circle in sufficient detail. Upon determining that the circle is imaged in insufficient detail, the level of illumination would be increased, resulting in overexposure of the square and triangle but revealing the desired detail of the circle as per inset (a).

There is an analogy between this aspect of the invention and automatic exposure control in cameras which achieve a similar outcome by adjusting shutter speeds and/or aperture sizes. However, by controlling the level of illumination all other device settings can remain constant, with no effect on depth of field or image stability that can result from wide exposures and long shutter times (respectively).

Generally, the object of interest will be the object (or other feature) which is central to the observation device's field of view, such as in inset (a). However, it may be possible to select the object (or other feature) of interest manually. Alternatively, it may be possible to adjust the level of illumination according to a desired distance, which might be irrespective of a particular object or feature being at that distance. In such an example, the level of illumination may be adjusted in direct correlation to distance. In the examples shown in FIG. 8 for example, the square and the triangle are at approximately the same distance from the observation device, so appropriate illumination may be determined based solely on an estimate of this distance or by determining the distance through measurement (as above).

FIG. 8(c) shows an arrangement in which the lighting is optimised for the triangle which is slightly further away from the observation device 801. In this image, the circle is insufficiently illuminated and the square is slightly overexposed, but the detail within the triangle is maximised. Compare with inset (b) where the square is in sufficient detail and the triangle is slightly underexposed.

It will be understood that while the various examples above are described in terms of a first image and a second image (and optionally additional images, where appropriate) and a single resultant image, the process will preferably, and likely in practical implementation, be carried out in real time such that method or process steps are repeated indefinitely so as to generate a live image and/or video stream which continually generates a desirable resultant (be it a merged or compensated) image for display to a user. This is illustrated by way of the feedback loop in FIG. 9.

The invention provides an observation device, such as a night vision device, a range finder, a sighting device, or a scope, with a more useful night vision image during use. One embodiment obtains night-vision images of a scene at different illuminations and merging the night-vision images, resulting in a merged image that exhibits greater dynamic range than any of the individual night-vision images. This may be achieved by selecting regions in each image which contain the greatest image detail and combining the selected regions from each image into a single image which exhibits greater image detail as a result. Illumination may be provided at different illumination levels and/or at different beam angles, and may be provided by the same or by different illuminators. Another embodiment obtains night-vision images of a scene at different illuminations and determines the level of detail of an object of interest in a first night-vision image at a first illumination so as to determine a second illumination that increases the level of detail in a second night-vision image.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. An observation device comprising:
a night vision imaging module; and
image processing means;
wherein the night vision imaging module is configured to capture a first night vision image of a scene and a second night vision image of substantially the same scene;
wherein the image processing means is configured to generate a merged night-vision image from the first image and the second image; and
wherein the first night-vision image is captured at a first illumination and the second night-vision image is captured at a second illumination such that the merged night-vision image exhibits a greater dynamic range than the first image or the second image alone.

2. The observation device of claim 1, wherein the observation device comprises an illuminator which is controlled to provide illumination at first and second illumination levels and/or beam angles.

3. The observation device of claim 1, wherein the observation device comprises a first illuminator which provides illumination at a first illumination level and/or beam angle and a second illuminator which provides illumination at a second illumination level and/or beam angle.

4. The observation device of claim 1, wherein the first night-vision image is captured at a low level of illumination and/or wide beam angle, and the second night-vision image is captured at a high level of illumination and/or narrow beam angle, optionally by controlling a single illuminator or switching between two different illuminators.

5. (canceled)

6. (canceled)

7. (canceled)

8. (canceled)

9. The observation device of claim 1, wherein the image processing means is configured to generate the merged night vision image from the first image, the second image, and any additional images, using tone mapping and/or exposure fusion.

10. (canceled)

11. The observation device of claim 1, wherein the first night-vision image of the scene is captured at a first exposure and the second night-vision image is captured at a second exposure, optionally the first and second images are captured at different shutter times and/or different aperture sizes.

12. (canceled)

13. The observation device of claim 1, wherein merging the first image, the second image, and any additional images, includes identifying preferred or desired parameters or quantities of each image, generating a corresponding weight map for each image, and combining the first image, the second image, and any additional images using weighted blending based on the weight maps.

14. The observation device of claim 13, wherein regions of low detail and/or low contrast are allocated a low weight in the respective weight map, and/or wherein regions of zero or near-zero brightness and regions of maximum or near-maximum brightness are allocated a low weight in the respective weight map.

15. The observation device of claim 1, wherein the image processing means is configured to generate the merged night vision image by selecting regions from the first image, the second image, and any additional images which contain greatest image detail, and combining the selected regions from the first image, the second image, and any additional images into a single image.

16. The observation device of claim 1, wherein the illumination, and optionally the exposure, is controlled responsive to a brightness of the merged night vision image, and optionally the exposure reduced or increased if the image brightness exceeds or falls below a threshold.

17. The observation device of claim 1, wherein the observation device is configured to determine the distance to a target or object of interest, optionally based on the focussing distance of the night vision imaging module, using a rangefinder, and wherein the observation device is configured to control the illumination, and optionally the exposure, responsive to the distance.

18. (canceled)

19. The observation device of claim 1, wherein the observation device comprises one or more additional imaging modules, wherein the image processing means is configured to generate a composite image in which a portion of an image obtained by an additional imaging module is superimposed on the merged night vision image generated by the image processing means, or vice versa.

20. (canceled)

21. (canceled)

22. A method of generating a night vision image of a scene, the method comprising:
capturing a first night vision image of the scene;
capturing a second night vision image of substantially the same scene; and
generating a merged night vision image from the first image and the second image;
wherein the first night-vision image is captured at a first illumination and the second night-vision image is captured at a second illumination such that the merged night vision image exhibits a greater dynamic range than the first image or the second image alone.

23. The method of claim 22, wherein the first night vision image is captured at a first illumination level, first beam angle and/or first exposure and the second night vision image is captured at a second illumination level, second beam angle and/or second exposure.

24. (canceled)

25. (canceled)

26. The method of claim 14, comprising controlling the illumination, beam angle and/or the exposure responsive to a brightness of the merged night vision image.

27. An observation device comprising:
a night vision imaging module; and
image processing means;
wherein the night vision imaging module is configured to capture a first night vision image of a scene at a first illumination and a second night vision image of substantially the same scene at a second illumination; and
wherein the image processing means is configured to determine the level of detail of an object of interest in the first night vision image and determine the second illumination to increase the level of detail of the object of interest in the second night vision image.

28. (canceled)

29. (canceled)

30. (canceled)

31. (canceled)

32. (canceled)

33. (canceled)

34. The observation device of claim 16, wherein the image processing means is configured to determine the level of detail of the object of interest based on the degree of contrast in the first image and/or a comparison between the mean and the median brightness of pixels in the first image.

35. (canceled)

36. The observation device of claim 16, wherein the image processing means is configured to analyse a histogram and determine an illumination to increase or maximise the number of intensity values within the histogram, and/or to determine the distance to the object of interest and to control the illumination responsive to the distance.

37. (canceled)

38. (canceled)

39. (canceled)

40. (canceled)

41. A method of generating a night vision image of a scene, the method comprising:
capturing a first night vision image of the scene at a first illumination;
analysing the first night vision image of the scene; and
capturing a second night vision image of substantially the same scene at a second illumination;
wherein analysing the first night vision image of the scene includes determining the level of detail of an object of interest in the first night vision image and determining the second illumination to increase the level of detail of the object of interest in the second night vision image.

42. (canceled)

43. (canceled)

44. (canceled)

45. The method of claim 41, comprising reducing the illumination if the brightness exceeds a threshold and/or if the contrast is below a threshold, and increasing the illumination if the brightness falls below a threshold and/or if the contrast exceeds a threshold.

46. (canceled)

47. (canceled)
